(19) United States
(12) Patent Application Publication
(10) Pub. No.: US 2020/0234363 A1
(43) Pub. Date: Jul. 23, 2020

(54) METHOD AND SYSTEM FOR WATERCRAFT LEASE MANAGEMENT

(71) Applicant: UFLOATZ PTY LTD, Malaga, Western Australia (AU)

(72) Inventors: Joseph Anthony SHANNON, Malaga (AU); Patrick Joseph NICHOLSON, Malaga (AU)

(21) Appl. No.: 16/650,043

(22) PCT Filed: Sep. 27, 2018
(86) PCT No.: PCT/AU2018/051053

§ 371 Date: Mar. 24, 2020

(30) Foreign Application Priority Data
Sep. 27, 2017 (AU) 2017903918

(51) Int. Cl. G06Q 30/06; G06Q 40/08; G06Q 10/02; H04W 4/021

(52) U.S. Cl. CPC G06Q 30/0645; H04W 4/021; G06Q 10/02; G06Q 40/08

(57) ABSTRACT

Provided is a system 300 for watercraft lease management for providing a first web portal whereby a plurality of watercraft owners 304 are able to register the leasing details for respective watercraft on a database in a memory arrangement of system 300, the leasing details including the watercraft specifications and insurance data. The processor also provides the second web portal whereby at least one potential watercraft lessee 302 is able to browse said database to select a particular watercraft for lease. The processor then registers the lease request, via the second web portal, which indicates the lessee's interest in leasing a particular watercraft, the lease request specifying the lease period and lessee data. Following this, the processor collates the request and relevant leasing details into an insurance request and transmits the insurance request via the network interface to an insurance provider 306 specified by the insurance data. Upon receipt from the insurance provider 306, by the system 300, of an electronic acceptance notification verifying inclusion of the lessee data with the insurance data for the lease period, the system 300 then confirms the lease request and accepts payment for leasing the particular watercraft to the lessee.

### TECHNICAL FIELD

This invention relates to the field of watercraft in general, and more specifically to a method and associated system for watercraft lease management.

### BACKGROUND ART

The following discussion of the background art is intended to facilitate an understanding of the present invention only. The discussion is not an acknowledgement or admission that any of the material referred to is or was part of the common general knowledge as at the priority date of the application.

Watercraft are water-borne vehicles, such as ships and boats, having some propulsive capability, like a sail or a motor. Despite rising ownership of watercraft worldwide, it typically comes along with high upfront costs and high running costs.

Paradoxically, many watercraft owners find that they use such watercraft infrequently, with many boats in marinas rarely leaving the marinas. This is due to a variety of reasons, including lack of time or upkeep and maintenance chores getting in the way of actual boating.

From a financial perspective, owning a boat can be a burden, as ongoing maintenance, storage and running costs are often more than initially anticipated, particularly when actual use of the boat is less than initially anticipated.

For this reason, Applicant has identified a need in the art to provide better return on investment for watercraft owners. Accordingly, the present invention seeks to propose possible solutions, at least in part, in amelioration of some of the known shortcomings in the art of watercraft ownership.

### SUMMARY OF THE INVENTION

According to a first aspect of the invention there is provided an automated computer-implemented method for watercraft lease management, said method comprising the steps of:
providing a first web portal whereby a plurality of watercraft owners is able to register leasing details for respective watercraft on a database, the leasing details including watercraft specifications and insurance data;
providing a second web portal whereby at least one potential watercraft lessee is able to browse said database to select a particular watercraft for lease;
registering a lease request, via the second web portal, indicating lessee interest in leasing a particular watercraft, said lease request specifying lease period and lessee data;
collating, by a processor, the lease request and relevant leasing details into an insurance request and transmitting said insurance request to an insurance provider specified by the insurance data, the insurance request soliciting inclusion of the lessee data with the insurance data for the lease period;
upon receipt from the insurance provider, by the processor, of an electronic acceptance notification verifying inclusion of the lessee data with the insurance data for the lease period, confirming the lease request and accepting payment for leasing the particular watercraft to the lessee; and
electronically transferring a portion of the payment to a financial account indicated by the leasing details of the relevant watercraft owner.

Typically, the watercraft specifications are selected from a group consisting of watercraft type, watercraft dimensions, watercraft capabilities, watercraft licence requirements, etc.

Typically, the insurance data specifies details of the insurance provider and an insurance policy of the watercraft.

Typically, the leasing details are selected from a group comprising watercraft availability, watercraft location, watercraft usage restrictions, owner financial account, etc.

Typically, the lease period specifies a time period in days and/or hours during which the lessee desires to lease the watercraft.

Typically, the step of collating the lease request and leasing details into the insurance request includes uniquely identifying the relevant watercraft insurance policy and insurance-relevant details of the lessee, so that the insurance provider is able to decide if the lessee is qualified for inclusion onto the insurance policy.

Typically, the lease request specifies a particular geographic location where the lessee will take possession of the watercraft at the commencement of the lease period.

In one example, the method includes the step of arranging collection of the watercraft from the owner prior to the leasing period and launching said watercraft at the particular geographic location specified in the lease request.

Typically, the step of arranging collection and launching comprises transmitting an automated request to a contractor, said automated request providing details of the lease request.

In one example, the method includes the step of arranging retrieval of the watercraft from the particular geographic location at an end of the leasing period.

Typically, the step of arranging retrieval includes arranging cleaning and inspection of the watercraft.

Typically, the step of arranging retrieval comprises transmitting an automated request to a contractor, said automated request providing details of the lease request.

According to a second aspect of the invention there is provided a system for watercraft lease management, said system comprising:
a non-transitory memory arrangement;
a communications network interface for operative connection to a communications network; and
a processor arranged in signal communication with the memory arrangement and the network interface, said processor adapted to automatically:
provide a first web portal whereby a plurality of watercraft owners is able to register leasing details for respective watercraft on a database in the memory arrangement, the leasing details including watercraft specifications and insurance data;
provide a second web portal whereby at least one potential watercraft lessee is able to browse said database to select a particular watercraft for lease;
register a lease request, via the second web portal, indicating lessee interest in leasing a particular watercraft, said lease request specifying lease period and lessee data;
collate, by the processor, the request and relevant leasing details into an insurance request and transmitting said insurance request via the network interface to an insurance provider specified by the insurance data, the insurance request soliciting inclusion of the lessee data with the insurance data for the lease period;
upon receipt from the insurance provider, by the processor, of an electronic acceptance notification verifying inclusion of the lessee data with the insurance data for the lease period, confirm the lease request and accept payment for leasing the particular watercraft to the lessee; and
electronically transfer a portion of the payment to a financial account indicated by the leasing details of the relevant watercraft owner.

Typically, the watercraft specifications are selected from a group consisting of watercraft type, watercraft dimensions, watercraft capabilities, watercraft licence requirements, etc.

Typically, the insurance data specifies details of the insurance provider and an insurance policy of the watercraft.

Typically, the leasing details are selected from a group comprising watercraft availability, watercraft location, watercraft usage restrictions, owner financial account, etc.

Typically, the lease period specifies a time period in days and/or hours during which the lessee desires to lease the watercraft.

Typically, the processor collates the lease request and leasing details into the insurance request by uniquely identifying the relevant watercraft insurance policy and insurance-relevant details of the lessee, so that the insurance provider is able to decide if the lessee is qualified for inclusion onto the insurance policy.

Typically, the lease request specifies a particular geographic location where the lessee will take possession of the watercraft at the commencement of the lease period.

In one example, the processor is configured to arrange collection of the watercraft from the owner prior to the leasing period and launch said watercraft at the particular geographic location specified in the lease request.

Typically, the processor is configured to arrange collection and launch by transmitting an automated request to a contractor, said automated request providing details of the lease request.

In one example, the processor is configured to arrange retrieval of the watercraft from the particular geographic location at an end of the leasing period.

Typically, processor is configured to arrange cleaning and inspection of the watercraft.

Typically, the processor is configured to arrange retrieval, cleaning and inspection by transmitting an automated request to a contractor, said automated request providing details of the lease request.

According to a further aspect of the invention there is provided a computer programme product which, when executed by a suitable processing system, facilitates the performance of a method by the processing system, said method comprising the steps of:
providing a first web portal whereby a plurality of watercraft owners are able to register leasing details for respective watercraft on a database, the leasing details including watercraft specifications and insurance data;
providing a second web portal whereby at least one potential watercraft lessee is able to browse said database to select a particular watercraft for lease;
registering a lease request, via the second web portal, indicating lessee interest in leasing a particular watercraft, said lease request specifying lease period and lessee data;
collating, by a processor, the lease request and relevant leasing details into an insurance request and transmitting said insurance request to an insurance provider specified by the insurance data, the insurance request soliciting inclusion of the lessee data with the insurance data for the lease period;
upon receipt from the insurance provider, by the processor, of an electronic acceptance notification verifying inclusion of the lessee data with the insurance data for the lease period, confirming the lease request and accepting payment for leasing the particular watercraft to the lessee; and
electronically transferring a portion of the payment to a financial account indicated by the leasing details of the relevant watercraft owner.

Typically, the watercraft specifications are selected from a group consisting of watercraft type, watercraft dimensions, watercraft capabilities, watercraft licence requirements, etc.

Typically, the insurance data specifies details of the insurance provider and an insurance policy of the watercraft.

Typically, the leasing details are selected from a group comprising watercraft availability, watercraft location, watercraft usage restrictions, owner financial account, etc.

Typically, the lease period specifies a time period in days and/or hours during which the lessee desires to lease the watercraft.

Typically, the step of collating the lease request and leasing details into the insurance request includes uniquely identifying the relevant watercraft insurance policy and insurance-relevant details of the lessee, so that the insurance provider is able to decide if the lessee is qualified for inclusion onto the insurance policy.

Typically, the lease request specifies a particular geographic location where the lessee will take possession of the watercraft at the commencement of the lease period.

In one example, the method includes the step of arranging collection of the watercraft from the owner prior to the leasing period and launching said watercraft at the particular geographic location specified in the lease request.

Typically, the step of arranging collection and launching comprises transmitting an automated request to a contractor, said automated request providing details of the lease request.

In one example, the method includes the step of arranging retrieval of the watercraft from the particular geographic location at an end of the leasing period.

Typically, the step of arranging retrieval includes arranging cleaning and inspection of the watercraft.

Typically, the step of arranging retrieval comprises transmitting an automated request to a contractor, said automated request providing details of the lease request.

### BRIEF DESCRIPTION OF THE DRAWINGS

The description will be made with reference to the accompanying drawings in which:

FIG. 1 is a diagrammatic overview representation of steps comprising a method watercraft lease management, in accordance with an aspect of the present invention;

FIG. 2 illustrates a functional block diagram of an example processing system that can be utilised to embody or give effect to a particular embodiment of a system for watercraft lease management;

FIG. 3 illustrates an example network infrastructure that can be utilised to embody or give effect to a particular embodiment of the system of FIG. 2 communicating via a communications network; and

FIG. 4 illustrates a diagrammatic network infrastructure of one example of a system for watercraft lease management.

### DETAILED DESCRIPTION OF EMBODIMENTS

Further features of the present invention are more fully described in the following description of several non-limiting embodiments thereof. This description is included solely for the purposes of exemplifying the present invention to the skilled addressee. It should not be understood as a restriction on the broad summary, disclosure or description of the invention as set out above. In the figures, incorporated to illustrate features of the example embodiment or embodiments, like reference numerals are used to identify like parts throughout.

It is to be appreciated by the skilled addressee that, with the computer-implemented method 10 described herein, any reference to “means” specifically includes any one or more of a computer program product for use in a local or dispersed computing system, a computer readable modulated carrier signal for interpretation by a local or dispersed computing system, or a computer readable medium of instructions for enabling a local or dispersed computing system to provide such “means” within the context of the description. In addition, such “means” may further expressly comprise any of the hardware and/or software components, independently or in combination, provided for in the description below, as will be understood by the skilled addressee.

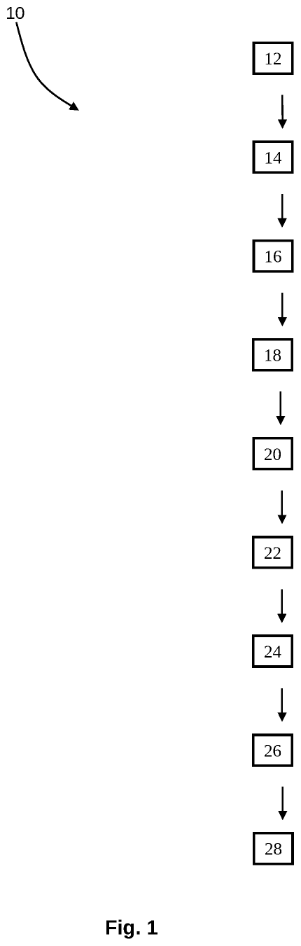

With reference now to FIG. 1 of the accompanying drawings, there is shown one broad example of a computer-implemented method 10 for watercraft lease management. In FIG. 1, typical method steps are represented by diagrammatic blocks, as shown. In the present example, the method 10 generally commences with a step of providing 12 a first web portal whereby a plurality of watercraft owners is able to register leasing details for respective watercraft on a database. Such leasing details typically include watercraft specifications and insurance data.

The first web portal is typically accessible via the Internet or similar communications network, by means of a personal computer, mobile phone or tablet of a watercraft owner. In such a manner, a watercraft owner can register their watercraft on the database by listing the leasing details. Such leasing details include the watercraft specifications, such as watercraft type, watercraft dimensions, watercraft capabilities, watercraft licence requirements, watercraft geographic location, etc. The leasing details also include the insurance data, which generally specifies details of the insurance provider and an insurance policy of the watercraft.

The leasing details can also specify watercraft availability, watercraft location, watercraft usage restrictions, owner financial account details, etc.

Next, the method 10 also includes a step of providing 14 a second web portal whereby at least one potential watercraft lessee is able to browse the database of watercraft to select a particular watercraft they are interested in for lease. A next step for the method 10 includes registering 16 a lease request received from the potential lessee via the second web portal. As mentioned, this lease request generally indicates the lessee's interest in leasing a particular watercraft selected from the database of watercraft. The lease request generally specifies a lease period and other lessee data, such as name, insurance rating, watercraft licences held, etc. The lease period generally specifies a time period in days and/or hours during which the lessee desires to lease the watercraft.

The method 10 then features the step of collating 18, by a processor or processing system (described in more detail below), the lease request and relevant leasing details into an insurance request. Once collated, the method 10 includes the step of transmitting 20 the insurance request to an insurance provider specified by the insurance data. This insurance request solicits or requests inclusion of the lessee data with the insurance data for the lease period, e.g. extending the watercraft owner's existing insurance policy to include the lessee for the lease period.

As will be appreciated by the skilled addressee, the step of collating 18 the lease request and leasing details into the insurance request typically includes uniquely identifying the relevant watercraft insurance policy and insurance-relevant details of the lessee, so that the insurance provider is able to decide if the lessee is qualified for inclusion onto the insurance policy.

The method 10 then features the step of, upon receipt from the insurance provider, by the processor or processing system, of an electronic acceptance notification which verifies or approves inclusion of the lessee data with the insurance data for the lease period, confirming 22 the lease request and accepting 24 payment for leasing the particular watercraft to the lessee.

In this manner, a binding lease agreement can be created between the lessee and the watercraft owner, whereby the lessee can enjoy use of the watercraft for the lease period in exchange for payment. Importantly, the watercraft is insured for such use by the lessee during the lease period.

The method 10 typically includes the step of electronically transferring 26 a portion of the payment to a financial account indicated by the leasing details of the relevant watercraft owner, i.e. the watercraft owner receives payment, generally minus an agency charge, or the like.

In a preferred embodiment, the lease request from the lessee specifies a particular geographic location where the lessee will take possession of the watercraft at the commencement of the lease period. In such an example, the method 10 may include the further steps of arranging 28 collection of the watercraft from the owner prior to the leasing period and launching said watercraft at the particular geographic location specified in the lease request. Such a step of arranging 28 collection and launching may comprise transmitting an automated request to a contractor providing details of the lease request, i.e. the lessee, the watercraft and the geographic location, or the like.

Similarly, the method 10 may include the step of arranging 28 retrieval of the watercraft from the particular geographic location at an end of the leasing period. This retrieval typically includes cleaning and inspection of the watercraft. As before, the step of arranging 28 retrieval comprises transmitting an automated request to a contractor, providing details of the lease request.

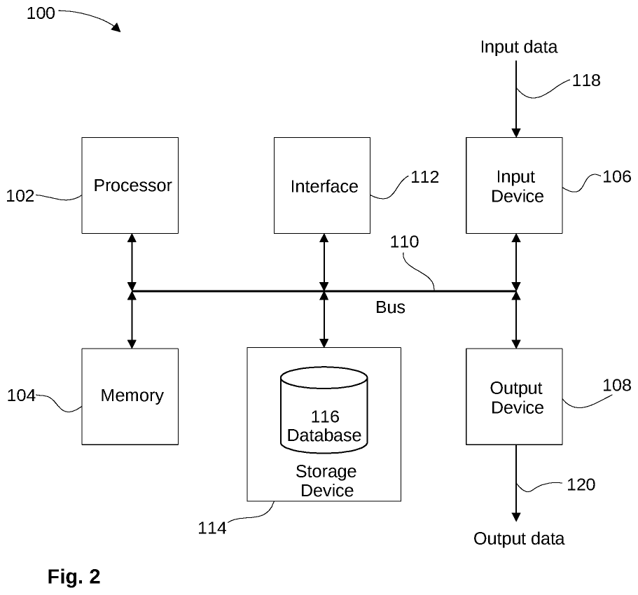

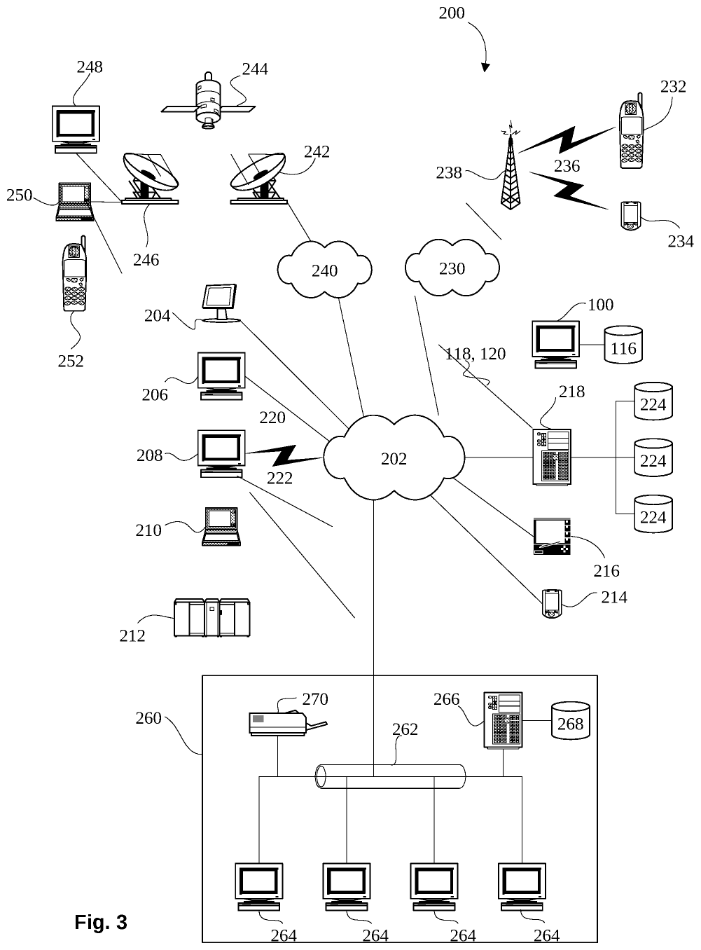

With reference now to FIGS. 2 and 3 of the accompanying drawings, the current disclosure further provides for an associated processing system 100 for performing the method 10. One specific embodiment of the system 300 will be described below, after general examples of such a processing system 100 and associated communications network 200 are provided, that can be used to implement the system 300, as will be understood by the skilled addressee.

In general, in a networked information or data communications system (an example shown in FIG. 3), a user has access to one or more terminals which are capable of requesting and/or receiving information or data from local or remote information sources. In such a communications system, a terminal may be a type of processing system, computer or computerised device, personal computer (PC), mobile, cellular or satellite telephone, tablet, mobile data terminal, portable computer, Personal Digital Assistant (PDA), pager, thin client, or any other similar type of digital electronic device as is known in the art. An example of such a processing system 100 is shown in FIG. 2 and described in more detail below.

The capability of such a terminal to request and/or receive information or data can be provided by software, hardware and/or firmware. A terminal may include or be associated with other devices, for example a local data storage device such as a hard disk drive or solid-state drive.

An information source can include a server, or any type of terminal, that may be associated with one or more storage devices that are able to store information or data, for example in one or more databases residing on a storage device. The exchange of information (i.e., the request and/or receipt of information or data) between a terminal and an information source, or other terminal(s), is facilitated by a communication means. The communication means can be realised by physical cables, for example a metallic cable such as a telephone line, semi-conducting cables, electromagnetic signals, for example radio-frequency signals or infra-red signals, optical fibre cables, satellite links or any other such medium or combination thereof connected to a network infrastructure.

The network infrastructure can include devices such as a telephone switch, base station, bridge, router, or any other such specialised network component, which facilitates the connection between a terminal and an information source. Collectively, an interconnected group of terminals, communication means, infrastructure and information sources is referred to as a network.

The network itself may take a variety of forms. For example, it may be a computer network, telecommunications network, data communications network, Local Area Network (LAN), Wide Area Network (WAN), wireless network, Internetwork, Intranetwork, the Internet and developments thereof, transient or temporary networks, combinations of the above or any other type of network providing for communication between computerised, electronic or digital devices.

More than one distinct network can be provided, for example a private and a public network. A network as referenced in this specification should be taken to include any type of terminal or other similar type of electronic device, or part thereof, which is rendered such that it is capable of communicating with at least one other terminal.

One embodiment of the system 100 of the present invention can be realised using a processing system 100, an example of which is shown in FIG. 2. In particular, the processing system 100 generally includes at least one processor 102, or processing unit or plurality of processors, memory 104, at least one input device 106 and at least one output device 108, coupled together via a bus or group of buses 110.

In certain embodiments, input device 106 and output device 108 could be the same device, e.g. a touchscreen. An interface 112 can also be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could include more than one distinct processing device, for example to handle different functions within the processing system 100.

Input device 106 receives input data 118 and can include, for example, a keyboard, a pointer device such as a pen-like device or a mouse, audio receiving device for voice-controlled activation such as a microphone, data receiver or antenna such as a modem or wireless data adaptor, data acquisition card, a touchscreen for receiving tactile input, etc. Input data 118 could come from different sources, for example keyboard instructions in conjunction with data received via a network. Output device 108 produces or generates output data 120 and can include, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network.

A user could view data output, or an interpretation of the data output, on, for example, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, the at least one database 116. The interface 112 may allow wired and/or wireless communication between the processing unit 102 and peripheral components that may serve a specialised purpose. The processor 102 receives instructions as input data 118 via input device 106 and can display processed results or other output to a user by utilising output device 108. More than one input device 106 and/or output device 108 can be provided. It should be appreciated that the processing system 100 may be any form of terminal, server, specialised hardware, or the like.

In addition, the processing system 100 is generally part of a networked communications system 200, as shown in FIG. 3. Processing system 100 could connect to network 202, for example the Internet or a WAN. Input data 118 and output data 120 could be communicated to other devices via network 202. Other terminals, for example, thin client 204, further processing systems 206 and 208, notebook computer 210, mainframe computer 212, PDA 214, pen-based computer 216, server 218, etc., can be connected to network 202. A large variety of other types of terminals or configurations could be utilised.

The transfer of information and/or data over network 202 can be achieved using wired communications means 220 or wireless communications means 222. Server 218 can facilitate the transfer of data between network 202 and one or more databases 224. Server 218 and one or more databases 224 provide an example of the watercraft lease management system.

Other networks may communicate with network 202. For example, telecommunications network 230 could facilitate the transfer of data between network 202 and mobile or cellular telephone 232 or a PDA-type device 234, by utilising wireless communication means 236 and receiving/transmitting station 238. Satellite communications network 240 could communicate with satellite signal receiver 242 which receives data signals from satellite 244 which in turn is in remote communication with satellite signal transmitter 246.

Terminals, for example further processing system 248, notebook computer 250 or satellite telephone 252, can thereby communicate with network 202. A local network 260, which for example may be a private network, LAN, etc., may also be connected to network 202. For example, network 202 could be connected with Ethernet 262 which connects terminals 264, server 266 which controls the transfer of data to and/or from database 268, and printer 270. Various other types of networks could be utilised.

The processing system 100 is adapted to communicate with other terminals, for example further processing systems 206, 208, by sending and receiving data, 118, 120, to and from the network 202, thereby facilitating possible communication with other components of the networked communications system 200.

Thus, for example, the networks 202, 230, 240 may form part of, or be connected to, the Internet, in which case, the terminals 206, 212, 218, for example, may be web servers, Internet terminals or the like. The networks 202, 230, 240, 260 may be or form part of other communication networks, such as LAN, WAN, Ethernet, token ring, FDDI ring, star, etc., networks, or mobile telephone networks, such as GSM, CDMA or 3G, etc., networks, and may be wholly or partially wired, including for example optical fibre, or wireless networks, depending on a particular implementation.

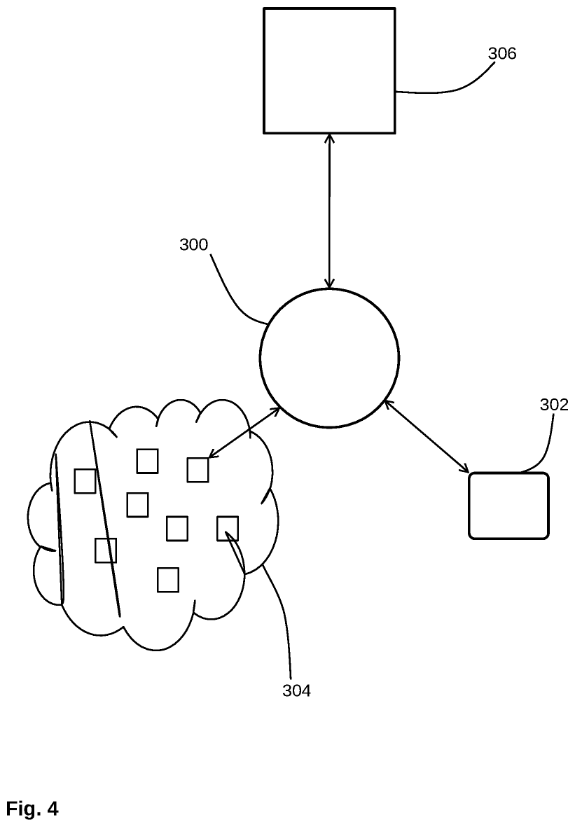

Referring now to FIG. 4 of the accompanying drawings, there is shown a specific example of a system 300 for watercraft lease management. As described above, such a system typically comprises a non-transitory memory arrangement, a communications network interface for operative connection to a communications network 200, and a processor arranged in signal communication with the memory arrangement and the network interface.

The processor of system 300 is generally adapted to provide the first web portal whereby a plurality of watercraft owners 304 are able to register the leasing details for respective watercraft on a database in the memory arrangement of system 300, the leasing details including the watercraft specifications and insurance data.

The processor also provides the second web portal whereby at least one potential watercraft lessee 302 is able to browse said database to select a particular watercraft for lease. The processor then registers the lease request, via the second web portal, which indicates the lessee's interest in leasing a particular watercraft, the lease request specifying the lease period and lessee data.

Following this, the processor collates the request and relevant leasing details into the insurance request and transmits the insurance request via the network interface to an insurance provider 306 specified by the insurance data. As described above, the insurance request solicits inclusion of the lessee data with the insurance data for the lease period.

Upon receipt from the insurance provider 306, by the system 300, of an electronic acceptance notification verifying inclusion of the lessee data with the insurance data for the lease period, the system 300 then confirms the lease request and accepts payment for leasing the particular watercraft to the lessee. The system 300 also generally facilitates electronic transfer of a portion of the payment to a financial account indicated by the leasing details of the relevant watercraft owner.

In the manner described above, the present invention is able to facilitate an automated agency service whereby watercraft owners can lease their watercraft to potential lessees without concern, given that the watercraft are covered by their existing insurance policies. The present invention facilitates a return-on-investments on watercraft ownership during times when such watercraft are not used.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth. In the example embodiments, well-known processes, well-known device structures, and well-known technologies are not described in detail, as such will be readily understood by the skilled addressee.

The use of the terms “a”, “an”, “said”, “the”, and/or similar referents in the context of describing various embodiments (especially in the context of the claimed subject matter) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. As used herein, the term “and/or” includes any and all combinations of one or more of the associated listed items. No language in the specification should be construed as indicating any non-claimed subject matter as essential to the practice of the claimed subject matter.

It is to be appreciated that reference to “one example” or “an example” of the invention, or similar exemplary language (e.g., “such as”) herein, is not made in an exclusive sense. Various substantially and specifically practical and useful exemplary embodiments of the claimed subject matter are described herein, textually and/or graphically, for carrying out the claimed subject matter.

Accordingly, one example may exemplify certain aspects of the invention, whilst other aspects are exemplified in a different example. These examples are intended to assist the skilled person in performing the invention and are not intended to limit the overall scope of the invention in any way unless the context clearly indicates otherwise. Variations (e.g. modifications and/or enhancements) of one or more embodiments described herein might become apparent to those of ordinary skill in the art upon reading this application. The inventor(s) expects skilled artisans to employ such variations as appropriate, and the inventor(s) intends for the claimed subject matter to be practiced other than as specifically described herein.

Any method steps, processes, and operations described herein are not to be construed as necessarily requiring their performance in the particular order discussed or illustrated, unless specifically identified as an order of performance. It is also to be understood that additional or alternative steps may be employed.

1-25. (canceled)

26. A system for watercraft lease management, said system comprising:
a non-transitory memory arrangement;
a communications network interface for operative connection to a communications network; and
a processor arranged in signal communication with the memory arrangement and the network interface, said processor adapted to automatically:
provide a first web portal whereby a plurality of watercraft owners is able to register leasing details for respective watercraft on a database in the memory arrangement, the leasing details including watercraft specifications and insurance data;
provide a second web portal whereby at least one potential watercraft lessee is able to browse said database to select a particular watercraft for lease;
register a lease request, via the second web portal, indicating lessee interest in leasing a particular watercraft, said lease request specifying lease period, lessee data and a particular geographic location where the lessee will take possession of the watercraft at the commencement of the lease period;
collate, by the processor, the request and relevant leasing details into an insurance request and transmitting said insurance request via the network interface to an insurance provider specified by the insurance data, the insurance request soliciting inclusion of the lessee data with the insurance data for the lease period;
upon receipt from the insurance provider, by the processor, of an electronic acceptance notification verifying inclusion of the lessee data with the insurance data for the lease period, confirm the lease request and accept payment for leasing the particular watercraft to the lessee; electronically transfer a portion of the payment to a financial account indicated by the leasing details of the relevant watercraft owner;
arrange collection of the watercraft from the owner prior to the leasing period and launch of said watercraft at the particular geographic location specified in the lease request by transmitting an automated request to a contractor; and
arrange retrieval, cleaning and inspection of the watercraft from the particular geographic location at an end of the leasing period by transmitting an automated request to a contractor.

27. The system of claim 26, wherein the watercraft specifications are selected from a group consisting of watercraft type, watercraft dimensions, watercraft capabilities, and watercraft licence requirements.

28. The system of claim 26, wherein the insurance data specifies details of the insurance provider and an insurance policy of the watercraft.

29. The system of claim 26, wherein the leasing details are selected from a group comprising watercraft availability, watercraft location, watercraft usage restrictions, and owner financial account.

30. The system of claim 26, wherein the lease period specifies a time period in days and/or hours during which the lessee desires to lease the watercraft.

31. The system of claim 26, wherein the processor collates the lease request and leasing details into the insurance request by uniquely identifying the relevant watercraft insurance policy and insurance-relevant details of the lessee, so that the insurance provider is able to decide if the lessee is qualified for inclusion onto the insurance policy for the duration of the lease period.

32. An automated computer-implemented method for watercraft lease management, said method comprising the steps of:
providing a first web portal whereby a plurality of watercraft owners is able to register leasing details for respective watercraft on a database, the leasing details including watercraft specifications and insurance data;
providing a second web portal whereby at least one potential watercraft lessee is able to browse said database to select a particular watercraft for lease;
registering a lease request, via the second web portal, indicating lessee interest in leasing a particular watercraft, said lease request specifying lease period, lessee data and a particular geographic location where the lessee will take possession of the watercraft at the commencement of the lease period;
automatically collating, by a processor, the lease request and relevant leasing details into an insurance request and transmitting said insurance request to an insurance provider specified by the insurance data, the insurance request soliciting inclusion of the lessee data with the insurance data for the lease period;
upon receipt from the insurance provider, by the processor, of an electronic acceptance notification verifying inclusion of the lessee data with the insurance data for the lease period, automatically confirming the lease request and accepting payment for leasing the particular watercraft to the lessee;
electronically transferring a portion of the payment to a financial account indicated by the leasing details of the relevant watercraft owner;
arranging collection of the watercraft from the owner prior to the leasing period and launch of said watercraft at the particular geographic location specified in the lease request by transmitting an automated request to a contractor; and
arranging retrieval, cleaning and inspection of the watercraft from the particular geographic location at an end of the leasing period by transmitting an automated request to a contractor.

33. The method of claim 32, wherein the watercraft specifications are selected from a group consisting of watercraft type, watercraft dimensions, watercraft capabilities, and watercraft licence requirements.

34. The method of claim 32, wherein the insurance data specifies details of the insurance provider and an insurance policy of the watercraft.

35. The method of claim 32, wherein the leasing details are selected from a group comprising watercraft availability, watercraft location, watercraft usage restrictions, and owner financial account.

36. The method of claim 32, wherein the lease period specifies a time period in days and/or hours during which the lessee desires to lease the watercraft.

37. The method of claim 32, wherein the step of collating the lease request and leasing details into the insurance request includes uniquely identifying the relevant watercraft insurance policy and insurance-relevant details of the lessee, so that the insurance provider is able to decide if the lessee is qualified for inclusion onto the insurance policy for the duration of the lease period.

38. A computer programme product which, when executed by a suitable processing system, facilitates the automatic performance of a method in accordance with claim 32.
